(19) United States
(12) Patent Application Publication
(10) Pub. No.: US 2010/0251370 A1
(43) Pub. Date: Sep. 30, 2010

(54) NETWORK INTRUSION DETECTION SYSTEM

(75) Inventors: Meng Sun, Tianjin (CN); Tom Chen, Taipei (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei (TW)

(21) Appl. No.: 12/411,916

(22) Filed: Mar. 26, 2009

(51) Int. Cl. G06F 11/00

(52) U.S. Cl. 726/23; 726/1

(57) ABSTRACT

A network intrusion detection system applied to detect and monitor network packets. The network intrusion detection system decides to load and operate detection rules according to a current load. The network intrusion detection system includes a network connection unit, a storage unit, and a processing unit. The processing unit operates an alert correlation program, a plurality of detection rules, and a plurality of operation policies according to the received network packets. The alert correlation program applied to detect whether contents of the network packets conform to the detection rules, assign a resource consumption level to each detection rule, and categorize the detection rules to the operation policies according to the resource consumption levels. A loading level of the processing unit is decided according to a device load and an access load. The operation policies and the alert correlation program that the processing unit operates are decided according to the loading-level.

### BACKGROUND OF THE INVENTION

1. Field of Invention

The present invention relates to an intrusion detection system, and more particularly, to an intrusion detection system that may make corresponding adjustments for different resource consumptions.

2. Related Art

In the past, network security solutions usually achieve basic network security and protection by using anti-virus software and firewalls. Anti-virus software prevents a computer system from being infected by computer viruses. Firewalls protect personal data from being stolen. Although, through the firewalls and anti-virus software, malicious intrusions of most intended intruders of a computer system may be stopped, some hackers may still break through the firewalls and intrude the computer system. A network intrusion detection system (IDS) technology has been developed to protect data in computer systems from being stolen or malicious damages of computers. Used with a firewall, the intrusion detection system can prevent malicious intrusion from external networks or internal networks effectively. The intrusion detection system mainly discovers unauthorized or abnormal network packet activities in a computer system by monitoring and analyzing network activities of the system, and by analyzing all received network packets. When the system is intruded, the intrusion detection system generates an alarm for abnormal access behaviors in real time, and records results of statistics and analysis in a report. Generally speaking, the network intrusion detection system may be a computer/server, which is installed at important nodes in the Internet, such as a back end of a border router of an internal network, or a front end of a host of an important (to-be-protected) server/computer. Thus, an alert signal is generated in real time when malicious attacks or suspicious online activities are detected, so as to block or filter attacks generated in malicious connection. Thereby, the data stealing or damages when the inner network is attacked may be avoided. A major detection method of the network intrusion detection is signature based detection, behavioral anomaly detection, and protocol anomaly detection. A server of the network intrusion detection system checks network online statuses and contents of all packets transmitted through the server of the network intrusion detection system. When a network attack event or an abnormal event conforming to definitions by an administrator of the network intrusion detection system is discovered, an alert is then sent to inform the administrator of the network intrusion detection system to take defense, or further to record the abnormal events in a program or a log file.

The current network intrusion detection technology is categorized into two types: a network-based intrusion detection system or a host-based intrusion detection system. The network-based network intrusion detection system arranges a host of the network intrusion detection system at a relatively important end point of a network segment, and performs characteristic analysis on every data packet flowing through the host of the network intrusion detection or suspicious packet types. The host-based network intrusion detection system mainly analyzes and judges network login files of the host or the system. However, irrespective of the type of the network intrusion detection system, a lot of system resources must be consumed for intrusion detection, as the network intrusion detection system needs to analyze the type of every packet or even needs to resolve the packet contents.

However, the load on the host of the intrusion detection system is not always high, and the host of the intrusion detection system has a limited processing capacity. When the load on the host is high, it will certainly take longer time for the host to process all the check rules than the time when the load is low.

### SUMMARY OF THE INVENTION

In view of the foregoing problems, the present invention is to provide a network intrusion detection system. The network intrusion detection system is used to detect and monitor network packets. The network intrusion detection system decides to load and operate detection rules according to a current load.

To achieve the objective, the network intrusion detection system disclosed in the present invention comprises a network connection unit, a storage unit, and a processing unit. The network connection unit receives a plurality of network packets from a client. The storage unit is used to store the network packets, an alert correlation program, a plurality of detection rules, and a plurality of operation policies. The alert correlation program is used to detect whether contents of the network packets conform to the detection rules, assign a corresponding resource consumption level to each of the detection rules, and categorize the detection rules into the corresponding operation policies according to the different resource consumption levels. The processing unit is electrically connected to the network connection unit and the storage unit. The processing unit decides whether to operate the detection rules according to the following steps: a device loading of the processing unit and an access load of the network connection unit are obtained respectively; a loading level of the processing unit is decided according to the device load and the access load; decide to operate the corresponding operation policy and whether to operate the alert correlation program on each of the network packets according to the current load level.

The present invention provides an intrusion detection system. The intrusion detection system grades detection rules according to different threat degrees or execution frequencies to categorize the detection rules into different operation policies. Also, the corresponding operation policies are operated according to different load consumption periods. When a network access amount is great, real-time responses may not be provided for check rules with relatively low real-time requirements. When resource consumption of the intrusion detection system is relatively low, a check rule is then operated, and vice versa. As such, the intrusion detection system provides relatively high processing performance in a period of high resource consumption.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a network topology of an intrusion detection system according to a preferred embodiment of the present invention;

FIG. 2 is a schematic view of an operation process of the present invention; and

FIG. 3 is a schematic view of the operation of each load level.

### DETAILED DESCRIPTION OF THE INVENTION

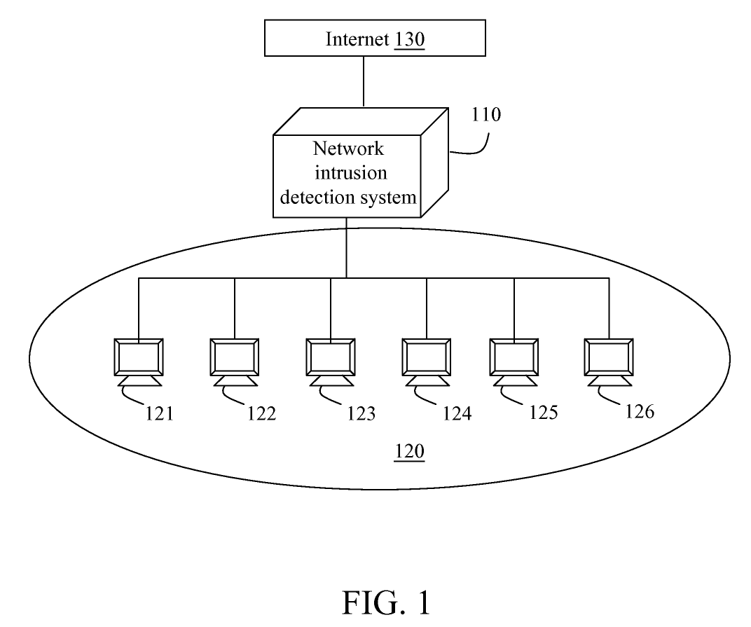

FIG. 1 is a schematic view of a network topology of an intrusion detection system according to a preferred embodiment of the present invention. Referring to FIG. 1, in this embodiment, all network packets will pass through a border node. Therefore, an intrusion detection system 110 is, for example, arranged at a border node (or a border router) of a local area network 120 to filter network packets with malicious intrusion/attacking behavior contents (referred to as malicious packets in the following), so as to protect computer hosts (121-126) inside the local area network 120 from being invaded by malicious packets from the internet 130.

A host of the intrusion detection system of the present invention at least comprises a network connection unit, a storage unit, and a processing unit. The network connection unit is used to connect a client in an external network/internal network, and to receive network packets sent by the client. The storage unit is used to store the received network packets, an alert correlation program, a plurality of detection rules, and a plurality of operation policies.

The detection rules include virus characteristic codes, system vulnerability characteristics, a plurality of intrusion behavior rules, and default communication protocols, source addresses, and connection ports corresponding to the intrusion behavior rules. For example, the detection rules for distributed denial-of-service (DDoS) are as shown in Table 1.

TABLE 1
DDoS Rule Table

| Detection Rule | Detection Content |
|---|---|
| Detection Rule 1: | Destination port: 445, |
| | Protocol: TCP, |
| | Packet number: 2, |
| | Packet size: 96 |
| Detection Rule 2: | Destination port: 445, |
| | Protocol: TCP, |
| | Packet number: 1, |
| | Packet size: 48 |
| Detection Rule 3: | Protocol: TCP, |
| | Packet number: 2, |
| | Packet size: 96 |

When it is found that the network packets conform to the detection rules, the network packets are checked by the alert correlation program then. Next, a corresponding resource consumption level is assigned to each detection rule, and the detection rules are categorized to the corresponding operation policies according to the different resource consumption levels. The processing unit is electrically connected to the network connection unit and the storage unit. The processing unit is used to detect all the received network packets according to the following steps.

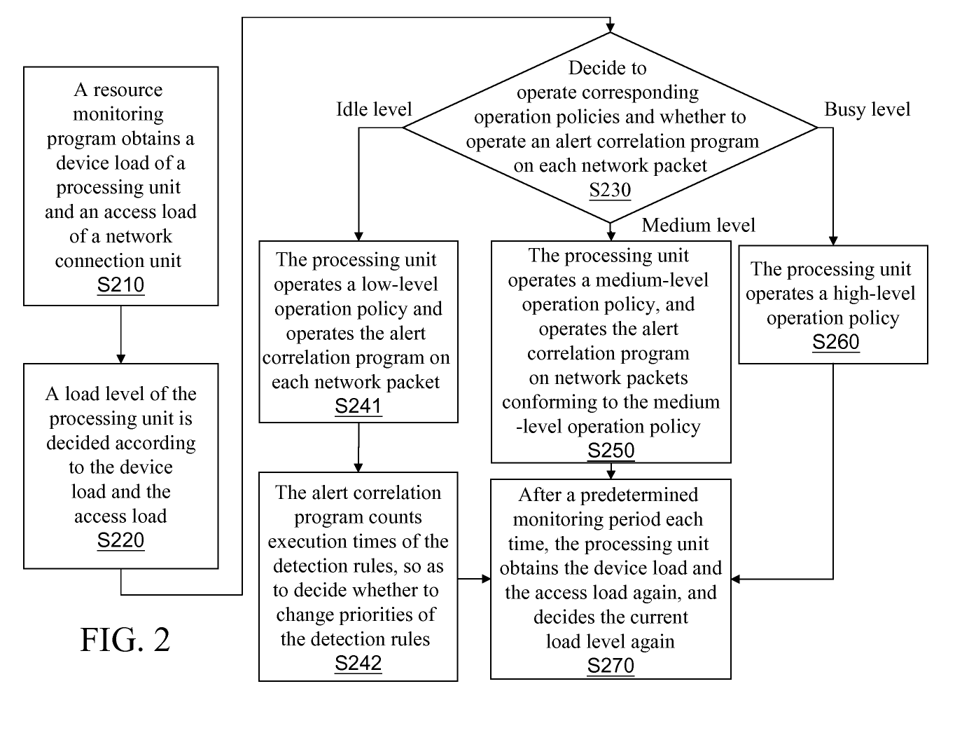

FIG. 2 is a schematic view of an operation process of the present invention.

A resource monitoring program obtains a device loading of the processing unit and an access load of the network connection unit (Step S210).

A loading level of the processing unit is decided according to the device load and the access load (Step S220).

Decide to operate the corresponding operation policy and whether to operate the alert correlation program on each network packet according to the current load level (Step S230).

When the load level is an idle level, the processing unit operates a low-level operation policy and operates the alert correlation program on each network packet (Step S241).

The alert correlation program counts execution times of the detection rules, so as to decide whether to change priorities of the detection rules (Step S242).

When the load level is a medium level, the processing unit operates a medium-level operation policy, and operates the alert correlation program on network packets conforming to the medium-level operation policy (Step S250).

When the load level is a busy level, the processing unit operates a high-level operation policy (Step S260).

After a predetermined monitoring period each time, the processing unit obtains the device load and the access load again, and decides the current load level again (Step S270).

The difference between the present invention and the prior art is an operation sequence and operation mode of the detection rules. The detection rules comprise a plurality of intrusion behavior rules, and default communication protocols, source addresses, and connection ports corresponding to the intrusion behavior rules. In Steps S210 and S220, the detection rules are categorized into different levels according to the load degrees of the processing unit and the network connection unit. To illustrate how to categorize the detection rules to the operation policies and how to decide the corresponding load levels more clearly, an example is given in the following. However, parameter settings are not only limited to those in the example.

First, a device load (Rc) of the processing unit and an access load (Rn) of the network connection unit are obtained. The device load (Rc) denotes a utility rate of the processing unit. The access load (Rn) denotes a network packet access rate of the network connection unit in a unit time. A resource consumption (Rr) of the intrusion detection system is:

Rr=Rc*right1+Rn*right2

where right1 and right2 are weights of the device load and the access load, respectively. The weights are decided according to processing capacities of the processing unit and the network connection unit. For example, in a rated network state, a set of appropriate weights are obtained through statistics on processing capacities of devices, such as the device loading of the processing unit, the access load of network packets, and a memory usage. Alternatively, the weights may be set by a user. Next, different load levels are set according to resource consumption levels. It should be noted that the load levels may not only be set in a fixed period, but also be distinguished according to the resource consumption levels.

Taking the fixed period for example, the load levels may then be divided into an idle period, a medium-level period, and a busy period. When the resource consumption of the intrusion detection system is less than a predetermined threshold value, the load level is then determined as the idle period. It is assumed here that 33% of the processing capacity of the intrusion detection system is a first threshold value (Lm), and 66% of the processing capacity of the intrusion detection system is a second threshold value (Lh). When the resource consumption is less than the first threshold value (Lm), the intrusion detection system is in the idle period. When the resource consumption is greater than or equal to the first threshold value (Lm), and smaller than or equal to the second threshold value (Lh), the intrusion detection system is in the medium-level period. If the resource consumption is greater than the second threshold value (Lh), the intrusion detection system is then in the busy period. For the first threshold value (Lm) and the second threshold value (Lh), it should be noted that the first threshold value (Lm) is greater a sum of a total load (Rca) and the total access load (Rcc) of the devices of the intrusion detection system (that is, (Rca+Rcc)*right1<Lm), and a difference between the second threshold value and the first threshold value (Lh−Lm) is greater than a sum of a total load (Rca) and the total access load (Rcc) of the devices of the intrusion detection system (that is, (Rca+Rcc)*right1<(Lh−Lm)).

The intrusion detection system is used to decide whether to operate the corresponding detection rules according to the current load level. Referring to the example above, the load levels are the idle period, the medium-level period, and the busy period. When the intrusion detection system is in the idle period, the intrusion detection system will adjust priorities of the detection rules according to execution frequencies of the alert correlation program. For example, if a malicious client sends aggressive network packets continuously, the intrusion detection system will make corresponding detection rule adjustments according to the current load level. When the load level is in the idle period/medium-level period, the intrusion detection system will start all the (or high-priority) detection rules. A frequency that the alert correlation program is triggered by the malicious client is also counted. When the triggering frequency is greater than an alert threshold, the priorities of the related detection rules triggered by the malicious client are raised, and vice versa.

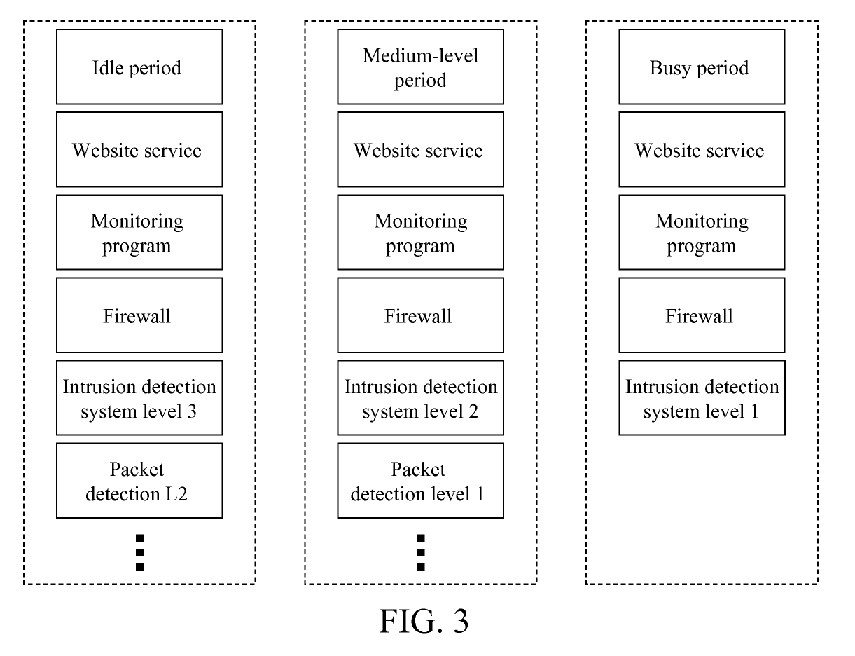

If the intrusion detection system is in the busy period, the processing unit only operates the high-level operation policy. In other words, only the check rules of high priorities are operated, and the alert correlation program does not process the network packets temporarily. When the loading level of the processing unit has descended to the medium-level period/idle period, the operation of the alert correlation program is then resumed. FIG. 3 is a schematic view of the operation of each load level.

In FIG. 3, from left to right are the idle period, the medium-level period, and the busy period, respectively. In different load levels, the intrusion detection system loads the same services, but the detection rules and the alert correlation program are somehow different. In the idle period, the intrusion detection system will load all the detection rules and the alert correlation program. In the medium-level period, the intrusion detection system will load a part of the detection rules and the alert correlation program. In the busy period, the intrusion detection system will only perform the detection rules of high priorities, and the alert correlation program is not operated temporarily.

In addition, in order to monitor statuses at different time in real time, after a monitoring period each time, the intrusion detection system will decide the current device load and access load, and decide the load level again. A monitoring frequency of the resource monitoring program may also be set at different load levels. For example, the resource monitoring program is set to perform scanning six times each hour when the intrusion detection system is in the idle period, five times each hour when the intrusion detection system is in the medium-level period, and three times each hour when the intrusion detection system is in the busy period, because the processing unit may have more capacity for resource consumptions of other programs in the idle period. On the contrary, the load of the processing unit is decreased when busy. When the resource monitoring program detects that the resource consumption of the processing unit exceeds the thresholds above during the monitoring time, the loading level of the processing unit is changed.

The present invention provides an intrusion detection system. The intrusion detection system grades the detection rules according to different threat degrees or execution frequencies to categorize the detection rules into different operation policies. The corresponding operation policies are operated according to different load consumption periods. Therefore, when the network access amount is large, real-time responses may not be provided for the check rules with relatively low real-time requirements. A check rule is operated only when the resource consumption of the intrusion detection system is relatively low, and vice versa. As such, the intrusion detection system provides relatively high processing performance in a period of high resource consumption.

What is claimed is:

1. A network intrusion detection system, for detecting and monitoring network packets, comprising:
a network connection unit, for receiving a plurality of network packets from a client or sending the network packets to the client;
a storage unit, for storing the received network packets, an alert correlation program, a resource monitoring program, a plurality of detection rules, and a plurality of operation policies, wherein the network packets are detected according to the detection rules, and the network packets conforming to the detection rules are sent to the alert correlation program for analysis, a corresponding resource consumption level and a priority is assigned to each of the detection rules, and the detection rules are categorized into the corresponding operation policies according to the different resource consumption levels; and
a processing unit, electrically connected to the network connection unit and the storage unit, wherein the processing unit decides whether to operate the detection rules according to the following steps:
obtaining an device loading of the processing unit and an access load of the network connection unit by the resource monitoring program;
deciding a loading level of the processing unit according to the device load and the access load; and
operating the corresponding operation policies to detect the network packets according to the current load level, and deciding to operate the alert correlation program on each of the network packets.

2. The network intrusion detection system according to claim 1, wherein the operation policies comprise a low-level operation policy, a medium-level operation policy, and a high-level operation policy, and the load levels comprise an idle level, a medium level and a busy level.

3. The network intrusion detection system according to claim 2, wherein the operating the alert correlation program further comprises:
performing the low-level operation policy by the processing unit and operating the alert correlation program on each of the network packets when the load level is the idle level;
performing the medium-level operation policy by the processing unit and operating the alert correlation program on the network packets conforming to the medium-level operation policy when the load level is the medium level; and
performing the high-level operation policy by the processing unit when the load level is the busy level.

4. The network intrusion detection system according to claim 3, further comprising the following step when the load level is the idle level:
deciding whether to change the priority of the detection rule by counting execution times of the detection rule by the alert correlation program.

5. The network intrusion detection system according to claim 1, wherein the operating the detection rule further comprises:
obtaining the device load and the access load again after a monitoring period each time to decide the load level in the current monitoring period.

6. The network intrusion detection system according to claim 1, wherein the detection rules comprise a plurality of intrusion behavior rules and default communication protocols, source addresses, and connection ports corresponding to the intrusion behavior rules.

7. The network intrusion detection system according to claim 1, wherein functions of the processing unit performs adding corresponding detection rules automatically according to communication protocols, source addresses, and connection ports in the network packets.
